(19) United States
(12) Patent Application Publication
(10) Pub. No.: US 2010/0175120 A1
(43) Pub. Date: Jul. 8, 2010

(54) MULTI-LAYER DATA MAPPING AUTHENTICATION SYSTEM

(76) Inventor: Chung-Nan Tien, Yonghe (TW)

Correspondence Address: RABIN & Berdo, PC, 1101 14TH STREET, NW, SUITE 500, WASHINGTON, DC, 20005, US

(21) Appl. No.: 12/637,916

(22) Filed: Dec. 15, 2009

Related U.S. Application Data
(60) Provisional application No. 61/142,725, filed on Jan. 6, 2009.

(51) Int. Cl. H04L 9/32

(52) U.S. Cl. 726/9

(57) ABSTRACT

A multi-layer data mapping authentication system has a real ID authentication server, a middle data mapping server and a terminal data mapping server. The real ID authentication server links to a private network and stores real IDs and the hidden codes, each of which corresponds to a unique real ID. The terminal data mapping server links to a public network and allows an end user to link so that the end user sends the terminal data mapping server a user's code and an one-time-password (OTP). Since the middle data mapping server links between the real ID authentication server and the terminal data mapping server, the end user only uses hidden code to generate the OTP and sends the user's code and the OTP to the public network. The terminal and middle data mapping servers are converts the user's code to the corresponding real ID of the end user in the private network to complete the authentication procedure. The real ID and hidden code is not sent at the public network and is not stolen.

### BACKGROUND OF THE INVENTION

1. Field of the Invention

The present invention relates to a data mapping authentication system, and more particularly to a data mapping authentication system that increases the on-line authentication security.

2. Description of Related Art

Nowadays, customers request higher and higher level security protection while they perform activities in Internet, one of the most important issues is to protect their passwords, and the most effective way to protect password is to adapt OTP (One Time Password).

The purpose of a one-time password (OTP) is to make it more difficult to gain unauthorized access to restricted resources, like a computer account. There are three basic types of OTP. The first type uses a mathematical algorithm to generate a new password based on the previous password. The second type that is based on time-synchronization between the authentication server and the client providing the password. The third type that is again using a mathematical algorithm, but the new password is based on a challenge and a counter instead of being based on the previous password. One example of the challenge is a random number chosen by the authentication server or transaction details.

With reference to FIG. 13, an authentication of a smart card is implemented by the third type of the OTP. The smart card issuer has a real identification (ID) authentication server and a real ID data database links to the real ID authentication server. The real ID data database stores multiple real Ids from different smart card users. The smart card user knows his or her real ID.

When the smart card user inserts his or her smart card into a card reader or smart user contact his or her smart card with a NFC (Near Field Communication) smart card reader, and the card user links to the Internet or the other unsecured communication path, the card user sends an authentication request to the smart card issuer (S1). The real ID authentication server generates a session ID to response the authentication request and then returns the return session ID to the card user (S2). Generally, for security enhancement issue, server will generate a session ID to smart card user and the smart card user have to input this session ID into the smart card reader to generate an OTP, and which session ID will be only valid for each authentation request.

The smart card reader automatically generates an OTP based on the session ID from the real ID authentication server. At the time, the card reader may ask the smart card user to input his or her PIN and then the OTP generated by the card reader (S3). Then the card user inputs the real ID and the OTP into the real ID authentication server (S4). The Real ID authentication server gets the real ID related data according to the received real ID (S5). The Real ID authentication server verifies correctness of the OTP according to the real ID related data and the session ID (S6). The real ID authentication server sends an authentication result back to the card user, so the smart card user will know the authentication result.

Since the smart card reader has to input his or her real ID, the real ID is still transmitted on the Internet or the unsecured communication path. Any unauthorized third one could steal the real ID from the Internet or the like. The security of the third type of the OTP has to be further improved.

### SUMMARY OF THE INVENTION

The main objective of the present invention is to provide a data mapping authentication system that increases the on-line authentication security.

The multi-layer data mapping authentication system has a real ID authentication server, a middle data mapping server and a terminal data mapping server. The real ID authentication server links to a private network and stores real IDs and the hidden codes, each of which corresponds to a unique real ID. The terminal data mapping server links to a public network and allows an end user to link so that the end user sends the terminal data mapping server a user's code and an one-time-password (OTP). Since the middle data mapping server links between the real ID authentication server and the terminal data mapping server, the end user only uses hidden code to generate the OTP and sends the user's code and the OTP to the public network. The terminal and middle data mapping servers convert the user's code to the corresponding real ID of the end user in the private network to complete the authentication procedure. The real ID is not sent at the public network and is not stolen.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a first embodiment of a data mapping authentication system in accordance with the present invention;

FIG. 2 is a schematic view of a second embodiment of a data mapping authentication system in accordance with the present invention;

FIG. 3 is a schematic view of a third embodiment of a data mapping authentication system in accordance with the present invention;

FIG. 4 is a schematic view of a fourth embodiment of a data mapping authentication system in which a first data mapping authentication method is implemented;

FIG. 5 is the schematic view of the fifth embodiment of the data mapping authentication system in which a second data mapping authentication method is implemented;

FIG. 6 is the schematic view of the sixth embodiment of the data mapping authentication system in which a third data mapping authentication method is implemented;

FIG. 7 is the schematic view of the seventh embodiment of the data mapping authentication system in which a fourth data mapping authentication method is implemented;

FIG. 8 is the schematic view of the eighth embodiment of the data mapping authentication system in which a fifth data mapping authentication method is implemented;

FIG. 9 is a schematic view of a ninth embodiment of the data mapping authentication system in accordance with the present invention;

FIG. 10 is a schematic view of a tenth embodiment of a payment system using the data mapping authentication system of FIG. 1 in accordance with the present invention;

FIG. 11 is a schematic view of a eleventh embodiment of a payment system using a sixth embodiment of a data mapping authentication system in accordance with the present invention;

FIG. 12 is the schematic view of FIG. 11 using another data mapping authentication method; and

FIG. 13 is a schematic view of a conventional data mapping authentication system in accordance with the prior art.

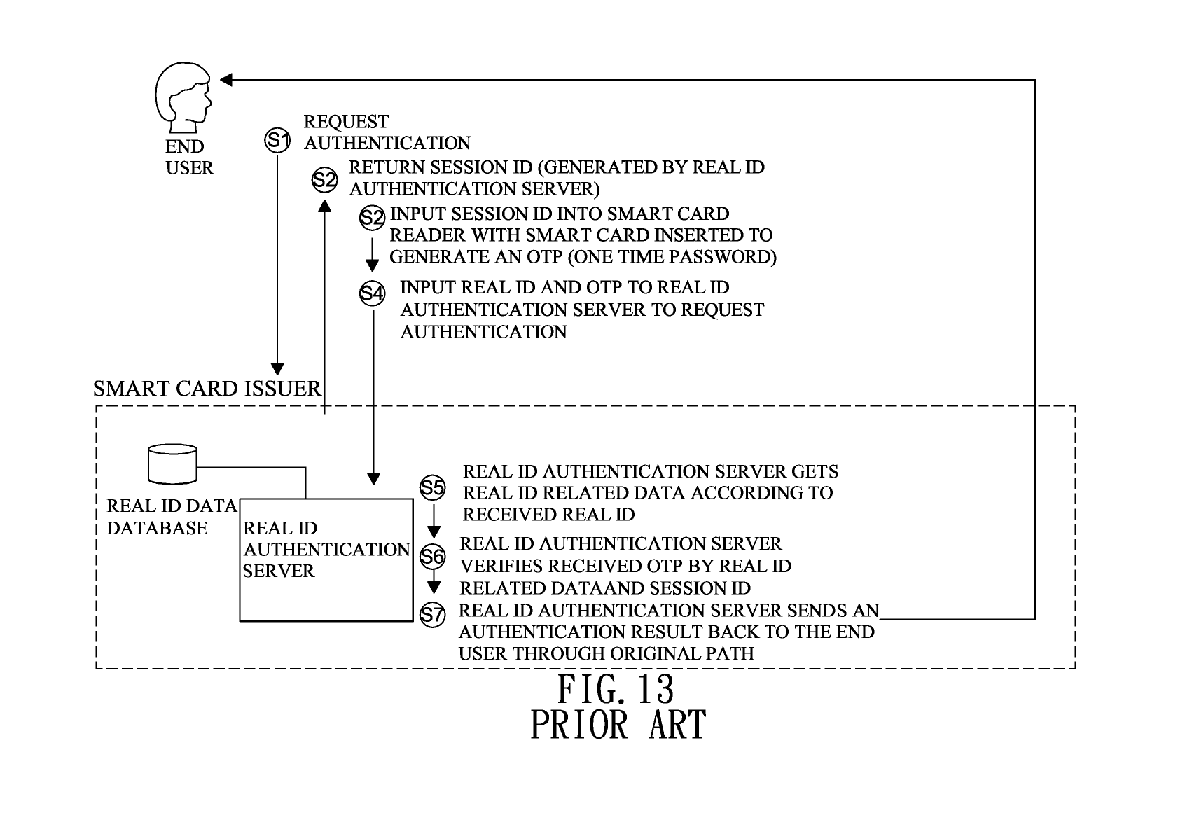

### DETAILED DESCRIPTION OF THE PREFERRED EMBODIMENT

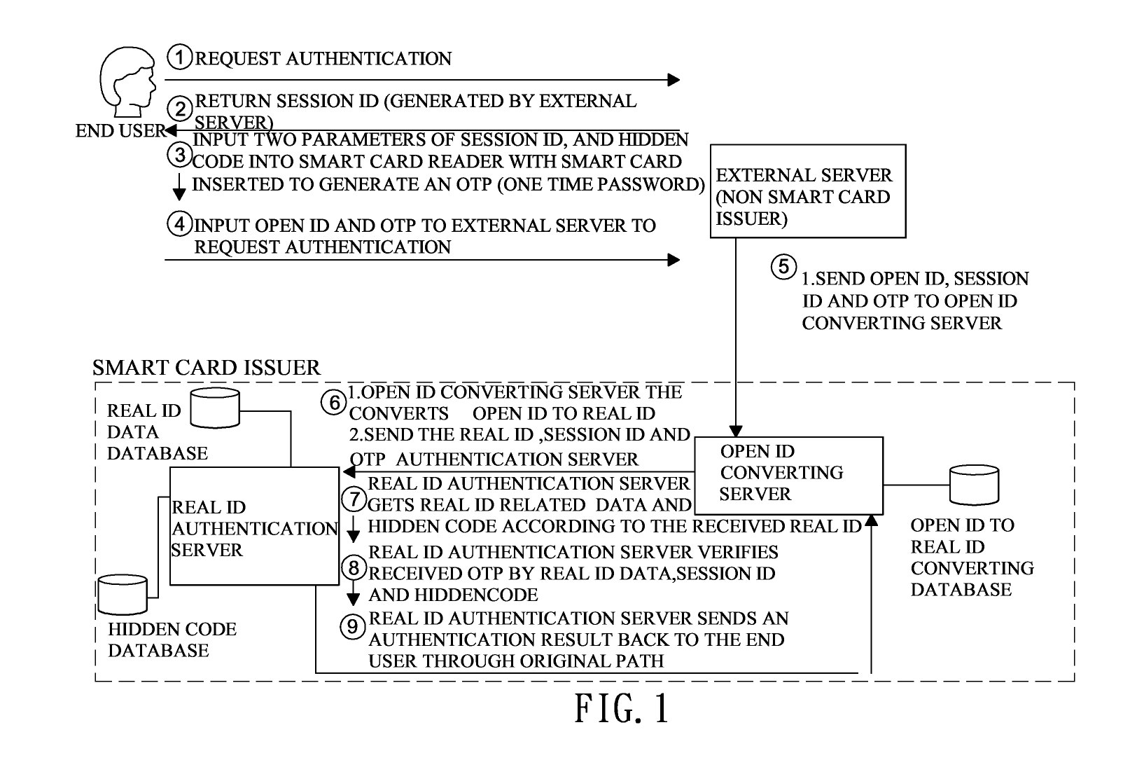

With reference to FIG. 1, a first embodiment of a multi-layer data mapping authentication system has a real identification (hereinafter ID) authentication server, a middle data mapping server and a terminal data mapping server. The middle data mapping server links to the real ID authentication server and the terminal data mapping server.

The real ID authentication server links to a private network and further has at least one real ID database and builds a third converting procedure. In the first embodiment, the real ID authentication server further has a hidden code database storing hidden codes therein. Each of the hidden codes is respectively corresponding to a unique real ID stored in the real ID database.

In the first embodiment, the middle data mapping server links to the private network and builds a second converting procedure. The middle data mapping server is an open ID converting server having a open ID to real ID converting database storing open IDs corresponding to real ID.

The terminal data mapping server links to a public network and end user can link to the terminal data mapping server and builds a first converting procedure. In the first embodiment, the terminal data mapping server is an external server. The end user provides his or her real ID to the real ID authentication server, one hidden code is provided to the end user by the real ID authentication server.

The terminal data mapping server starts to execute the first converting procedure by receiving an authentication request from end user, so the first converting procedure of the first embodiment has following steps of: (a) receiving the authentication request from the end user; (b) generating and responding a session ID to the end user; (c) receiving an open ID and an on-time-password (OTP) from the end user; and (d) sending the open ID, the session ID and the OTP to the open ID converting server. The OTP is generated by a smart card reader according to two parameters of the session ID and the hidden code. That is, the user inputs into a smart card reader with the two parameters of the session ID from the external server and the hidden code previously obtained from the real ID authentication server after obtaining the session ID from the external server.

The open ID converting server starts to execute the second converting procedure by receiving the open ID, the session ID and the OTP to the open ID converting server from the external server. Therefore, the second converting procedure has steps of: (a) receiving the open ID, the session ID and the OTP to the open ID converting server; (b) reading the open ID to real ID database to convert open ID to the corresponding real ID; and (c) sending the real ID, the session ID and the OTP to the real ID authentication server.

The real ID authentication server starts to execute the third converting procedure by receiving the real ID, the session ID and the OTP from the open ID converting server. Therefore, the third converting procedure has steps of: (a) receiving the real ID, the session ID and the OTP; (b) generating a real ID related data and recovering the hidden code according to the real ID; (c) verifying the OTP according to the real ID related data, session ID and the hidden code; and (d) generating and responding an authentication result to end user.

Based on the foregoing description, a basic data mapping authentication method mainly issues a hidden code to the end user and provides the terminal converting server and the middle data mapping server between the end user and the real ID authentication server. The terminal converting server and the middle data mapping server convert the open ID to the real ID, so the real ID authentication server normally verifies whether the end user's real ID is correct by the OTP with hidden code at the private network. That is, the real ID and hidden code is not stolen by the OTP at the public network.

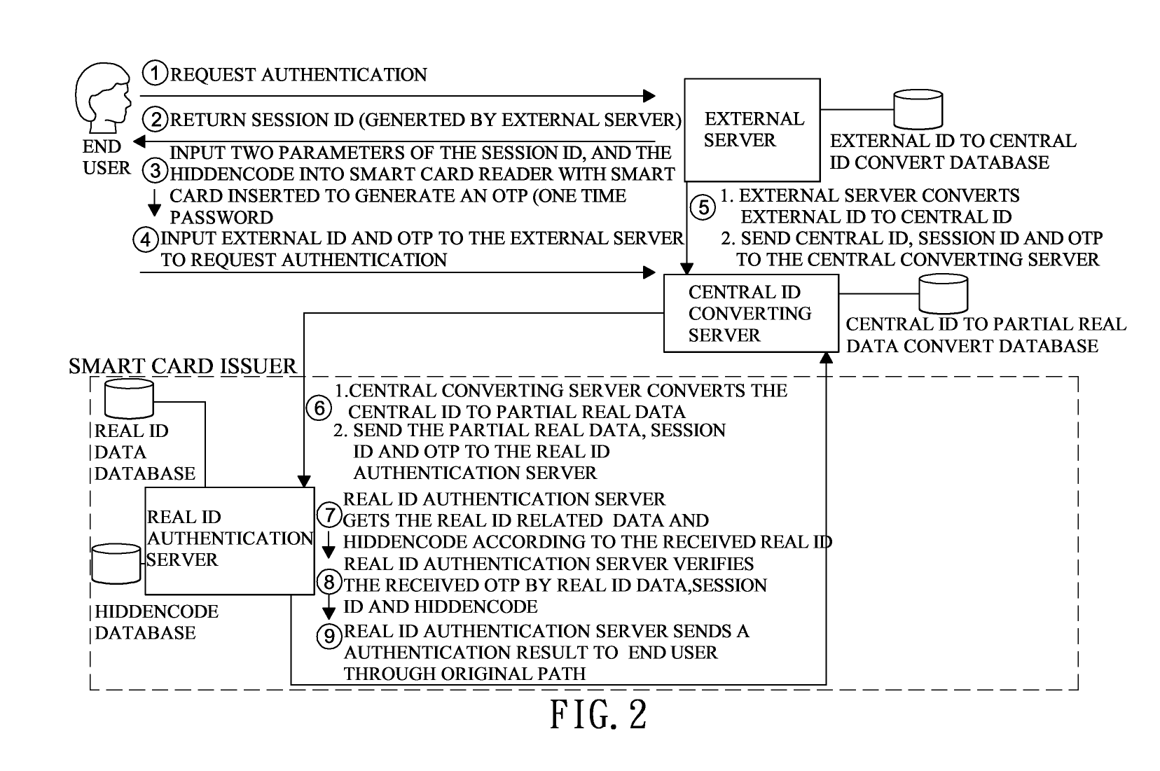

With reference to FIG. 2 a second embodiment of a multi-layer data mapping authentication system in accordance with the present invention is similar to the first embodiment thereof. In the second embodiment, a middle data mapping server links to the public network so the middle data mapping server is a central ID converting server having a central ID to partial real data converting database. That is, the central ID to partial real data converting database stores the central IDs and partial real data respectively corresponding to the central IDs. In addition, the external server further has an external ID to central ID converting database. The external ID to central ID converting database stores external IDs and central IDs.

Regarding to the second embodiment of the multi-layer data mapping authentication system, the first converting procedure has steps of: (a) receiving authentication request; (b) responding a session ID; (c) receiving the external ID and an OTP; (d) reading the external ID to central ID converting database to convert the external ID to the central ID; and (e) sending the central ID, the session ID and OTP to the central ID converting server.

In the second embodiment, the second converting procedure has steps of:

(a) receiving the central ID, the session ID and OTP; (b) reading the central ID to partial real data converting database to convert the central ID to the corresponding partial real data; and (c) sending the partial real data, the session ID and the OTP to the real ID authentication server.

The third converting procedure has steps of: (a) receiving the partial real data, the session ID and the OTP; (b) generating a real ID related data and recovering the hidden code according the partial real data; (c) verifying the OTP according to the real ID related data the session ID and hidden code; and (d) responding an authentication result to the end user, which partial real data is assembled by a part of rear ID related data.

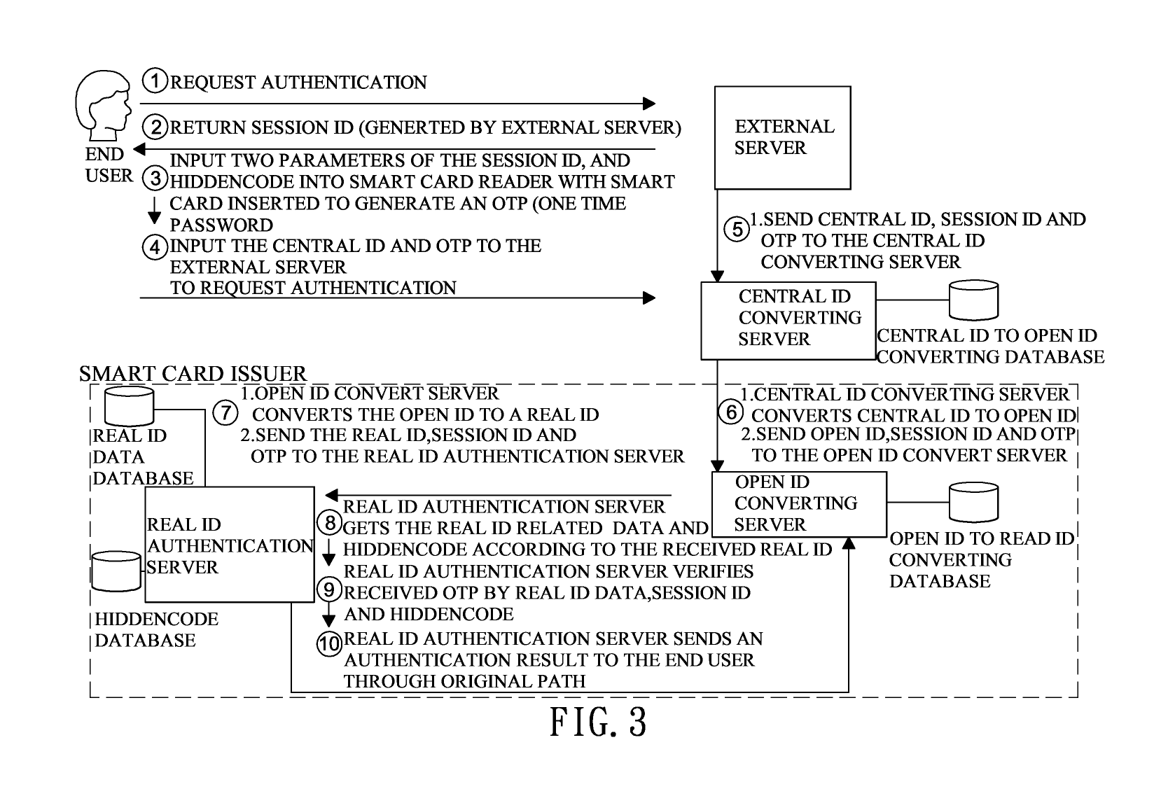

With reference to FIG. 3, a third embodiment of a multi-layer data mapping authentication system is a combination of the first and second embodiments in accordance with the present invention. A middle data mapping server has a central ID converting server and a open ID converting server. The central ID converting server has a central ID to open ID converting database and the open ID converting server has an open ID to real ID converting database. A terminal data mapping server is an external server having a first converting procedure.

A first converting procedure has steps of: (a) receiving an authentication request from the end user; (b) sending a session ID generated by terminal data mapping server; (c) receiving an central ID and an OTP; and (d) sending the central ID, the session ID and OTP to the central ID converting server. The OTP is generated by the smart card reader according to two parameters of the session ID and hidden code.

A second converting procedure has steps of: (a) receiving the central ID, the session ID and the OTP; (b) reading the central ID to open ID converting database to convert the central ID to the corresponding open ID; (c) sending the opening ID, the session ID and OTP to the open ID converting server; (e) reading the open ID to real ID converting database to convert the open ID to the corresponding real ID; (f) sending the real ID, the session ID and OTP to the real ID authentication server.

A third converting procedure executed by the real ID authentication server has steps of: (a) receiving the real ID, the session ID and OTP; (b) generating a real ID related data and recovering the hidden code according the real ID; (c) verifying the OTP according to the real ID related data the session ID and hidden code; and (d) responding an authentication result to the end user.

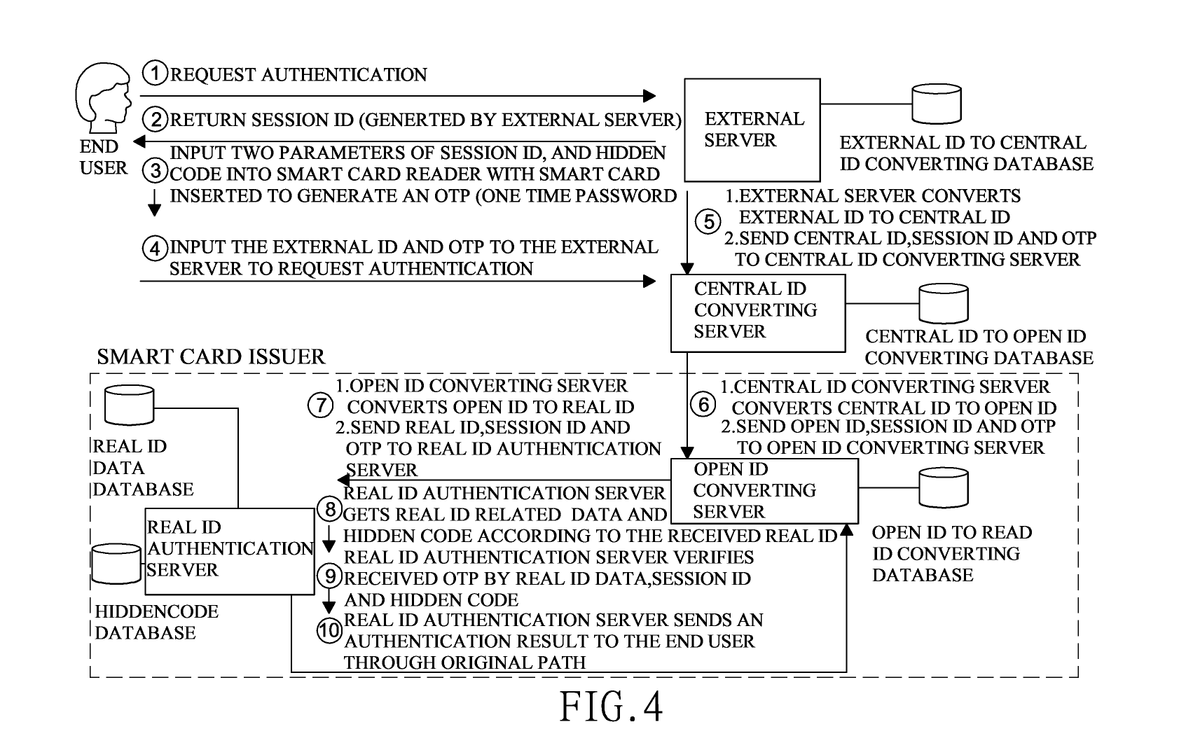

With reference to FIG. 4, a fourth embodiment of an authentication system in accordance with the present invention is similar to the third embodiment thereof and the difference between them is an external server. The external server further has an external ID to central ID converting database. The external ID to central ID converting database stores external IDs and central IDs respectively corresponding to the external IDs.

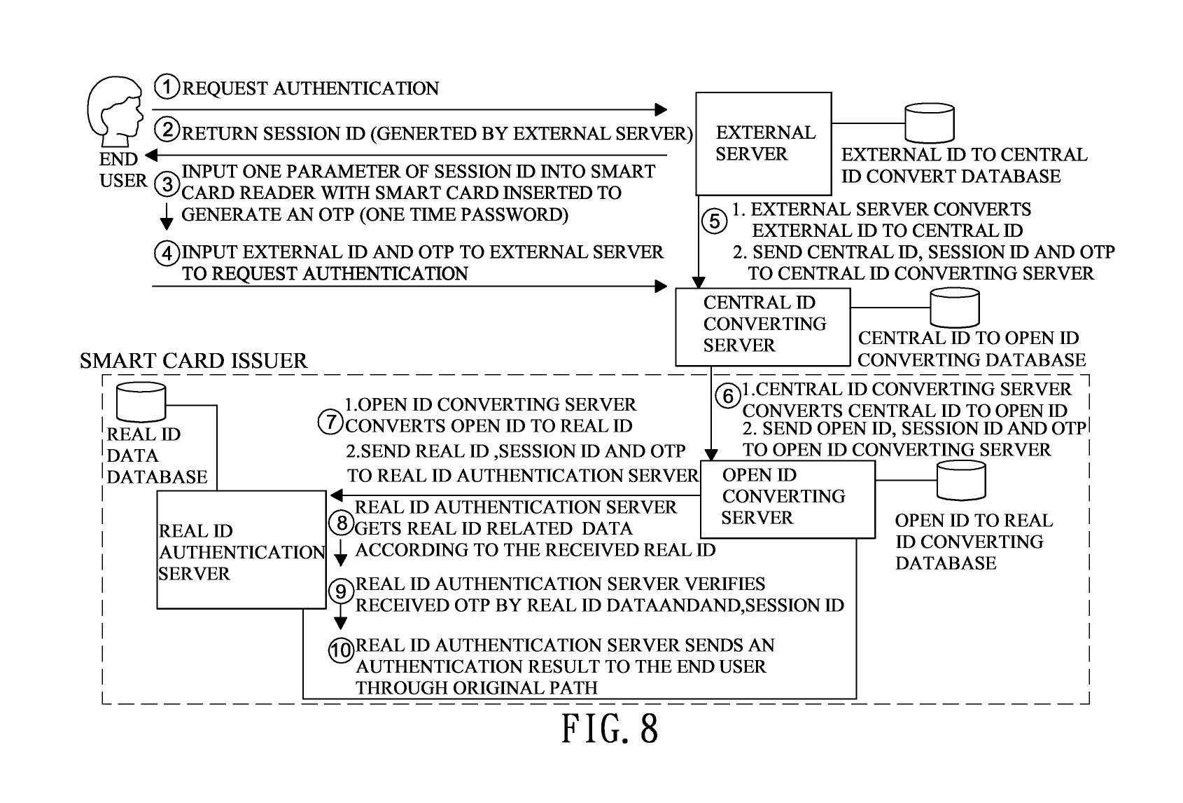

A first converting procedure of the external server has steps of: (a) receiving an authentication request; (b) sending a session ID generated by the external server; (c) receiving the external ID and an OTP; and (d) reading the external ID to central ID converting database to convert the external ID to the corresponding central ID; and (e) sending the central ID, the session ID and the OTP to the central ID converting server. In this embodiment, the end user inputs two parameters of the session ID and the hidden code into the smart card reader to generate a unique OTP. With further reference to FIG. 8, the smart card reader also generates the OTP by one parameter of the session ID.

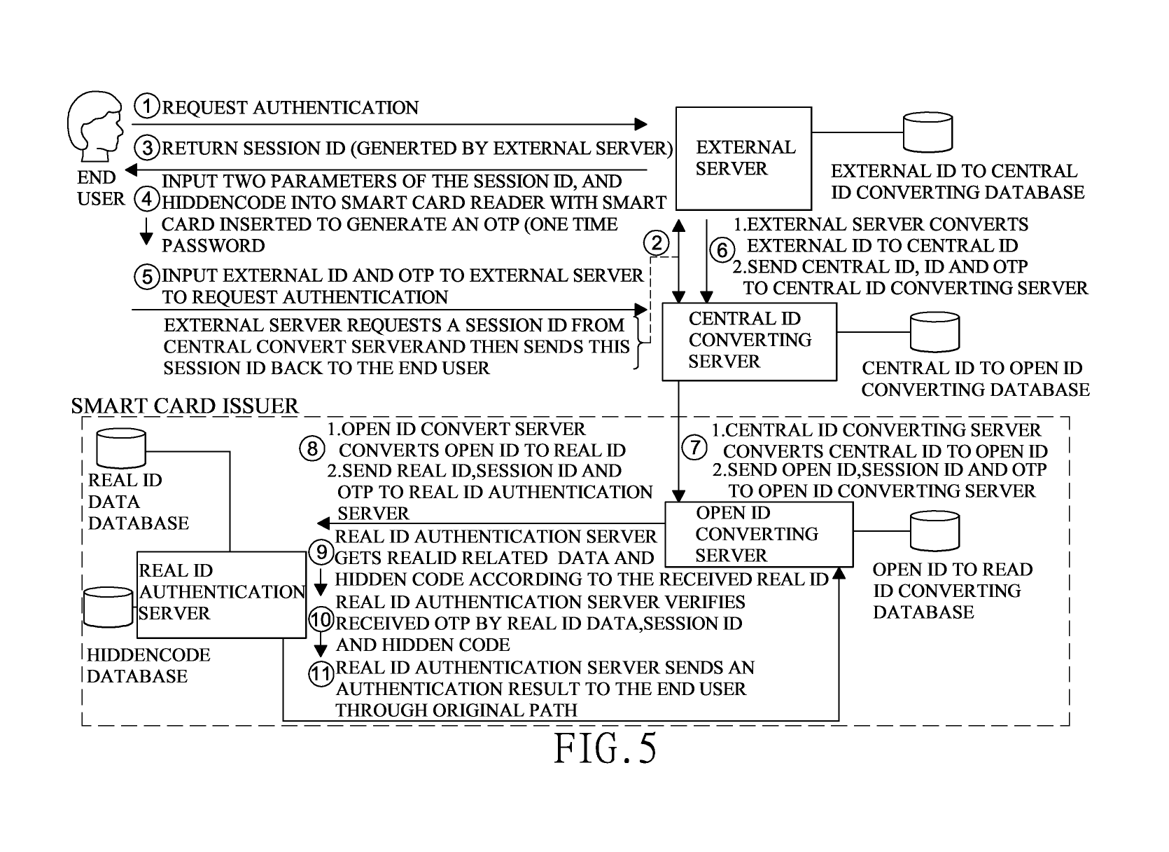

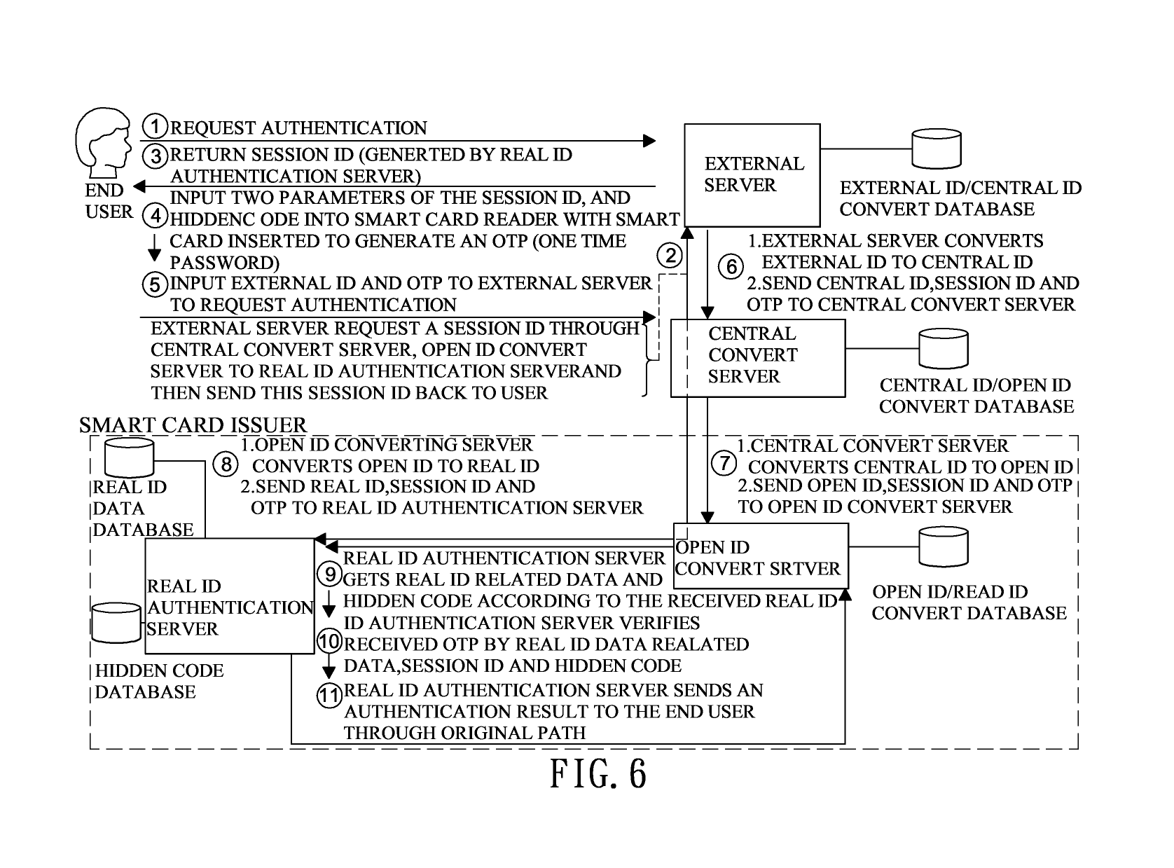

With further reference to FIG. 5, another first converting procedure has steps of: (a) receiving an authentication request; (b) sending a session ID request to the central ID converting server; (c) receiving the session ID generated by the central ID and then sending the session ID to the end user; (d) receiving the external ID and the OTP; (e) reading the external ID and central ID converting database to convert the external ID to the corresponding central ID; and (f) sending the central ID and the OTP to the central ID converting server. Since the session ID is generated by the central ID converting server, the external server does not send the session ID to the central ID converting server. With further reference to FIG. 6, another first procedure has steps of: (a) receiving an authentication request; (b) sending a session ID request to the real ID authentication server; (c) receiving the session ID generated by the real ID and then sending the session ID to the end user; (d) receiving the external ID and the OTP; (e) reading the external ID and central ID converting database to convert the external ID to the corresponding central ID; and (f) sending the central ID and the OTP to the central ID converting server.

Another second procedure has steps of: (a) receiving the central ID and OTP; (b) reading the central ID to open ID converting database to convert the central ID to the corresponding open ID; (c) sending the opening ID and the OTP to the open ID converting server; (d) reading the open ID to real ID converting database to convert the open ID to the corresponding real ID; (e) sending the real ID and the OTP to the real ID authentication server.

Another third converting procedure comprises steps of: (a) receiving the real ID and the OTP; (b) generating a real ID related data and recovering the hidden code according the real ID; (c) verifying the OTP according to the real ID related data and hidden code; and (d) responding an authentication result to the end user.

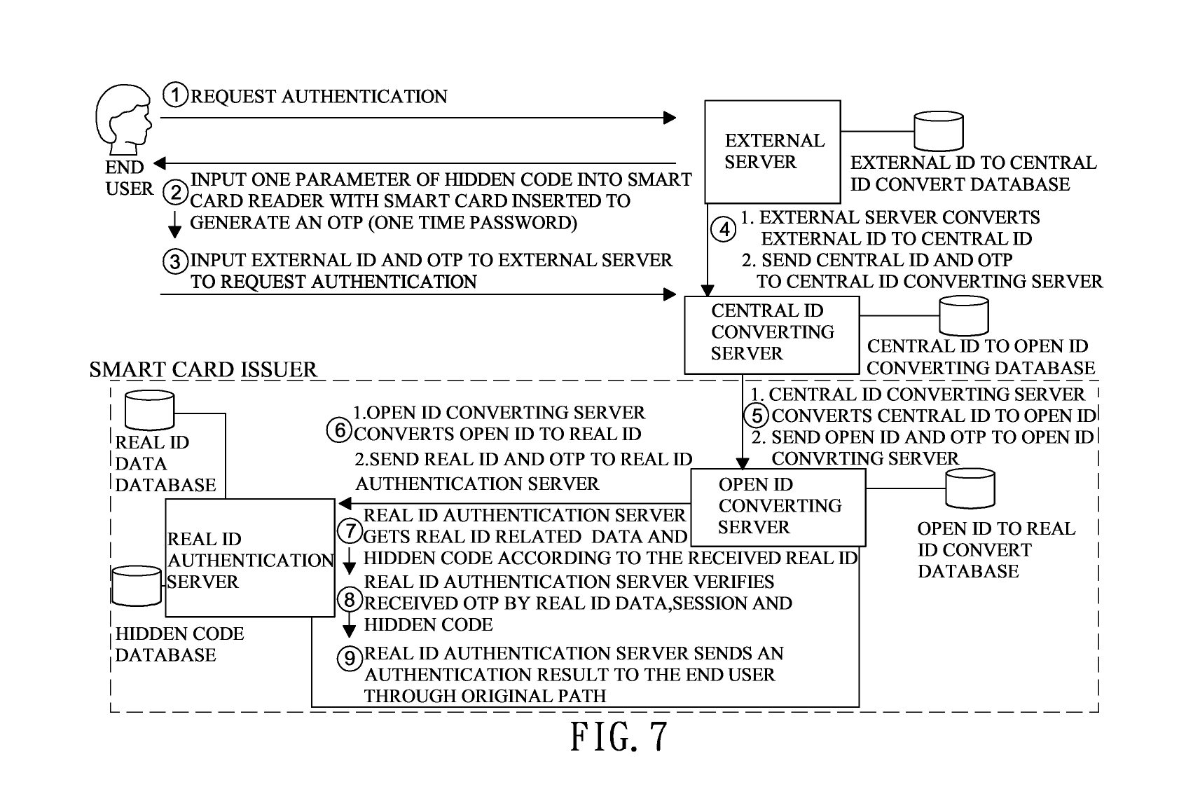

With further reference to FIG. 7, another first converting procedure has steps of: (a) receiving an authentication request; (b) receiving an external ID and OTP; (c) reading the external ID and central ID converting database to convert the external ID to the corresponding central ID; and (d) sending the central ID and the OTP to the central ID converting server. Since the external server does not response a session ID to the end user, the end user only inputs one parameter of Hidden code into the smart card reader with a smart card to generate an OTP.

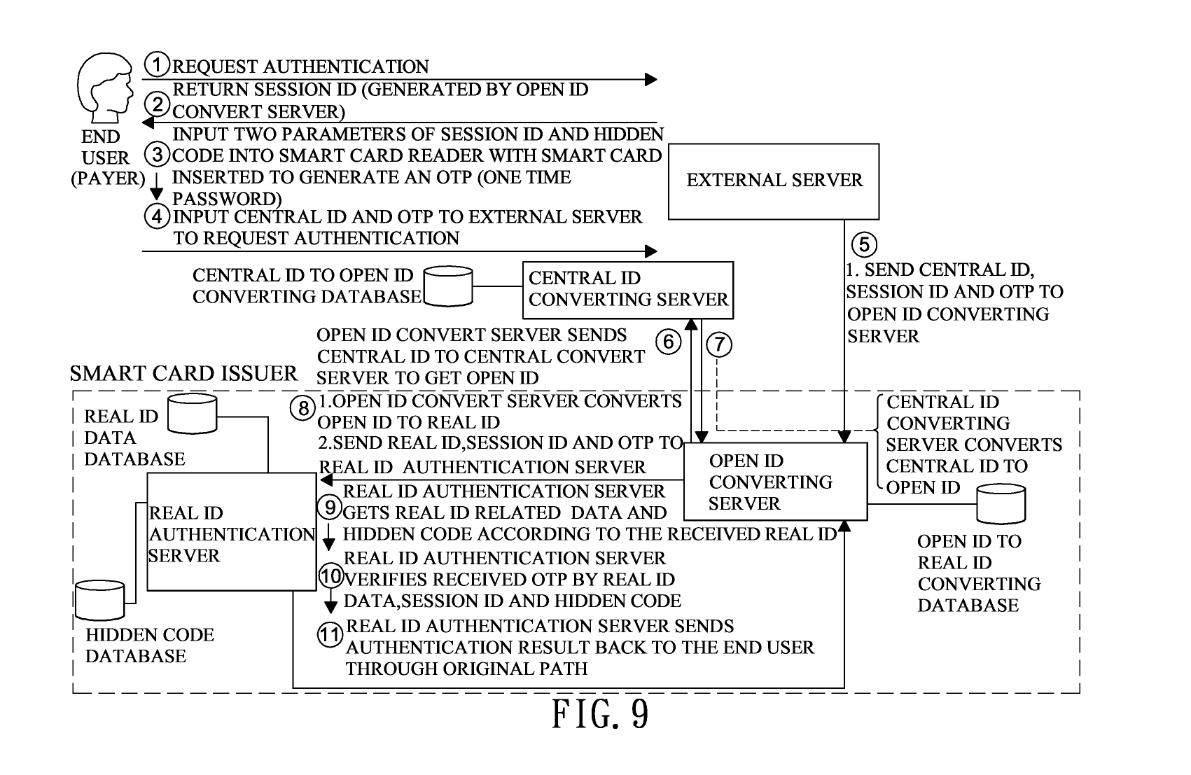

With reference to FIG. 9, a ninth embodiment of an authentication system in accordance with the present invention is similar to the third embodiment thereof. A middle data mapping server has an open ID converting server and a central ID converting server. An external server directly links to an open ID converting server of the middle data mapping server.

A first converting procedure of the external server has steps of: (a) receiving an authentication request; (b) sending the session ID generated by an external server; (c) receiving the central ID and the OTP; and (d) sending the central ID, the session ID and the OTP to the open ID converting server.

A second converting procedure of the middle data mapping server has steps of: (a) receiving the central ID, the session ID and the OTP; (b) sending the central ID to the central ID converting server; (c) converting the central ID to the corresponding open ID by the central ID converting server; (d) receiving the open ID from the central ID converting server and converting the open ID to the to corresponding real ID; and (e) sending the real ID, the session ID and OTP to the real ID authentication server.

A third converting procedure of the real ID authentication server has steps of: (a) receiving the real ID, the session ID and OTP; (b) generating a real ID related data and recovering the hidden code according the real ID; (c) verifying the OTP according to the real ID related data the session ID and hidden code; and (d) responding an authentication result to the end user.

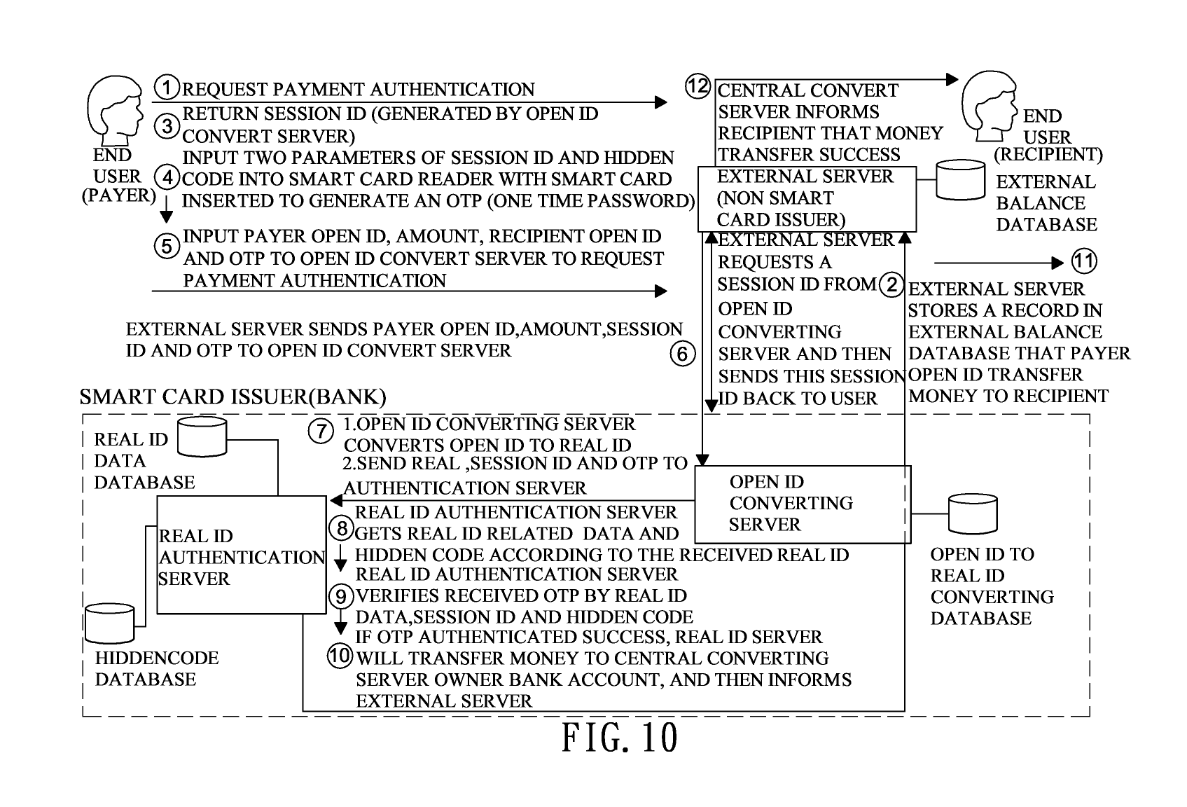

With reference to FIG. 10, the first embodiment of the multi-layer data mapping authentication system in accordance with the present invention is used to a payment system and the real ID authentication server further stores bank accounts corresponding to the real IDs. Therefore, the real ID authentication server built inside a bank or a smart card issuer and two end users (payer and recipient) can link to the external server to complete a payment procedure at the same time.

Another first converting procedure is implemented in the external server of the first embodiment and has steps of: (a) receiving the authentication request from the payer (b) sending a session ID request to the open ID converting server; (c) receiving and responding the session ID generated by open ID converting server; (d) receiving an open ID, amount, recipient's open ID and the OTP; and (e) sending the payer's open ID, the amount, the session ID and the recipient's open ID and the OTP to the open ID converting server.

A second converting procedure of the open ID converting server has steps of: (a) receiving payer's open ID, the amount, the session ID and the recipient's open ID and the OTP; (b) reading the open ID to real ID converting database to convert the payer's open ID to the corresponding real ID; and (c) sending the payer's real ID, the session ID and the OTP to the real ID authentication server.

A third converting procedure of the real ID authentication server has steps of: (a) receiving payer's real ID, the session ID and the OTP; (b) generating a real ID related data and recovering the hidden code according to the real ID; (c) verifying the OTP according to the real ID related data, session ID and the hidden code; (d) transferring the money from the payer's account to the recipient's bank account through the open ID converting server and central ID converting server if an authentication result is success; (e) sending a notice of successful payment to the recipient.

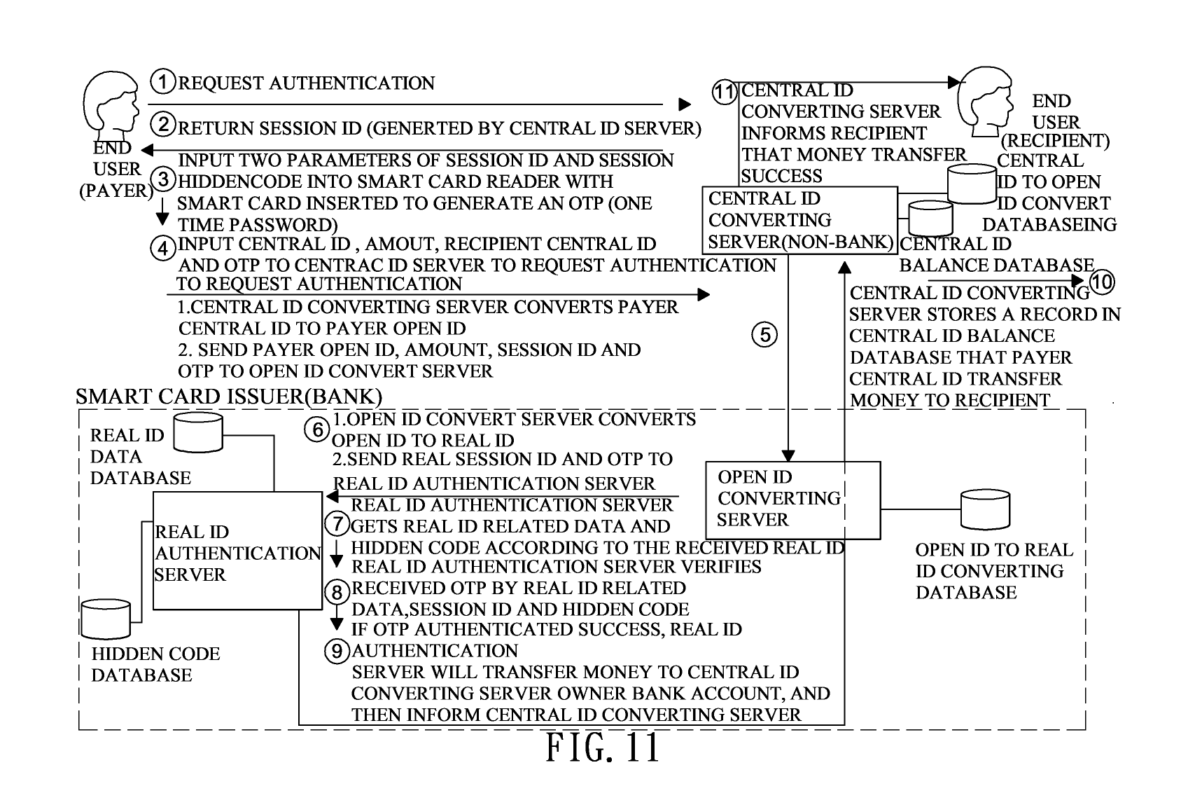

With reference to FIG. 11, another multi-layer data mapping authentication system is used to a payment system has a terminal data mapping server, a middle data mapping server and a real ID authentication server. The terminal data mapping server is a central ID converting server having a central ID to open ID converting database and a central ID balance database. The payer and recipient can link to the central ID to open ID converting database. The middle data mapping server is a open ID converting server.

A first converting procedure of the central ID converting server has steps of: (a) receiving a payment authentication request; (b) responding a session ID generated by a central ID converting server; (c) receiving a payer's central ID, amount, a recipient central ID and the OTP; (d) reading the central ID to open ID converting database to covert the payer's central ID to the corresponding open ID; and (d) sending the payer's open ID, amount, the session ID and the OTP to the open ID converting server.

A second converting procedure of the open ID converting server has steps of: (a) receiving the payer's open ID, amount, the session ID and the OTP; (b) reading the open ID to real ID converting database to convert the payer's open ID to the corresponding real ID; and (c) sending the payer's real ID, the session ID and the OTP to the real ID authentication server.

A third converting procedure of the real ID authentication server has steps of: (a) receiving the payer's real ID, the session ID and the OTP; (b) generating a real ID related data and recovering the hidden code according to the real ID; (c) verifying the OTP according to the real ID related data, the session ID and the hidden code; (d) transferring the money from the payer's account to the recipient's bank account through the open ID converting server and the central ID converting server if an authentication result is success; (e) sending a notice of successful payment to the recipient.

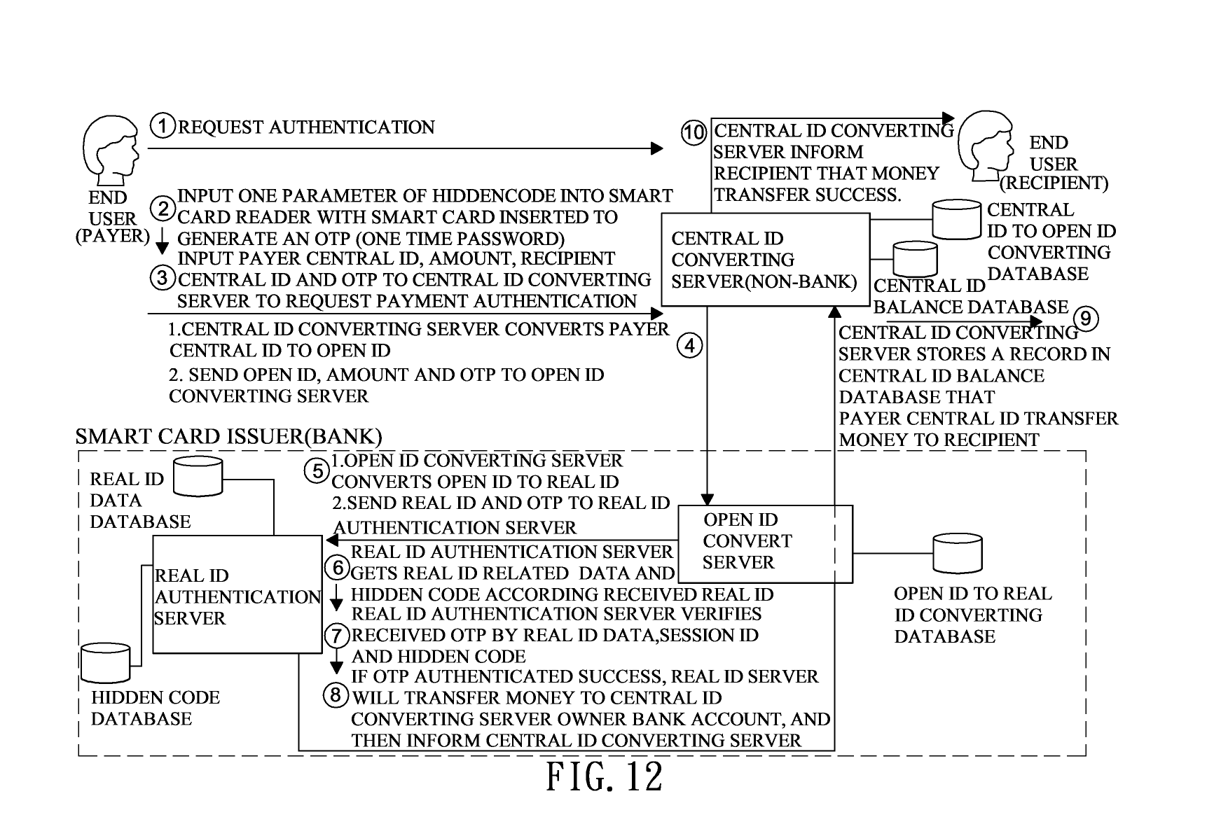

With further reference to FIG. 12, another first converting procedure of the central ID converting server has steps of: (a) receiving a payment authentication request; (b) receiving a payer's central ID, amount, a recipient central ID and the OTP; (c) reading the central ID to open ID converting database to covert the central ID to the corresponding open ID; and (d) sending the payer's open ID, the amount and the OTP to the open ID converting server.

Another second converting procedure of the open ID converting server has steps of: (a) receiving the payer's open ID, the amount and the OTP; (b) reading the open ID to real ID converting database to convert the payer's open ID to the corresponding real ID; and (c) sending the payer's real ID and OTP to the real authentication server.

Another third converting procedure has steps of: (a) receiving the payer's real ID, the session ID and the OTP; (b) generating a real ID related data and recovering the hidden code according to the real ID; (c) verifying the OTP according to the real ID related data, the session ID and the hidden code; (d) transferring the money from the payer's account to the recipient's bank account through the open ID converting server and the central ID converting server if an authentication result is success; (e) sending a notice of successful payment to the recipient.

Based on foregoing description, since the middle data mapping server links between the real ID authentication server and the terminal data mapping server, the end user only uses hidden code to generate the OTP and sends the user's code and the OTP to the public network. The terminal and middle data mapping servers convert the user's code to the corresponding real ID of the end user in the private network to complete the authentication procedure. The real ID is not sent at the public network and is not stolen. The security of the on-line authentication is increased.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-layer data mapping authentication system comprising:
a real ID authentication server linking to a private network and further having at least one real ID database and building a third converting procedure, wherein each of the at least one real ID database of the real ID authentication server stores real IDs and hidden codes, each of which corresponds to a unique real ID stored in the real ID database;
a middle data mapping server linking to real ID authentication server and building a second converting procedure, wherein the middle data mapping server has a public ID to real ID converting database storing public IDs, each of which corresponds to a unique real ID stored in the real ID database; and
a terminal data mapping server linking to a public network and the middle data mapping server, and building a first converting procedure, wherein the terminal data mapping server allows an end user to link so that the end user sends a user's code related to the corresponding public code of the middle data mapping server and an one-time-password (OTP) generated by a smart card reader according to the hidden code to request authentication;
whereby the terminal data mapping server coverts the user's code to the corresponding public ID and then sends the public ID and the OTP to the middle data mapping server; the middle data mapping server further converts the pubic ID to the corresponding real ID and then sends the real ID and OTP to the real ID authentication server; and the real ID authentication server converts the real ID to the real ID related data and the hidden code to verify the OTP.

2. The multi-layer data mapping authentication system as claimed in claim 1, wherein
the middle data mapping server links to the private network and has an open ID converting server and the public ID to real ID converting database is an open ID to real ID converting database, wherein the open ID is the public ID; and
the terminal data mapping server is an external server.

3. The multi-layer data mapping authentication system as claimed in claim 1, wherein the middle data mapping server links to the public network and has a central ID converting server and the public ID to real ID converting database is a central ID to real ID database storing partial real data of each real ID, wherein the public ID is central ID.

4. The multi-layer data mapping authentication system as claimed in claim 1, wherein the middle data mapping server comprises:
an open ID converting server linking to the private network and having an open ID to real ID converting database storing the open IDs and the real IDs; and
a central ID converting server linking to the public network and the open ID converting server, and having a central ID to open ID converting database storing the central IDs and the open IDs.

5. The multi-layer data mapping authentication system as claimed in claim 4, wherein the central ID converting server links to the terminal data mapping server, and the open ID converting server links to the real ID authentication server.

6. The multi-layer data mapping authentication system as claimed in claim 4, wherein the open ID converting server links to the terminal data mapping server.

7. The multi-layer data mapping authentication system as claimed in claim 3, wherein the terminal data mapping server has an external server having an external ID to open ID converting database.

8. The multi-layer data mapping authentication system as claimed in claim 5, wherein the terminal data mapping server has an external server having an external ID to central ID converting database.

9. The multi-layer data mapping authentication system as claimed in claim 6, wherein the terminal data mapping server has an external server having an external ID to central ID converting database.

10. The multi-layer data mapping authentication system as claimed in claim 2, wherein
the first converting procedure comprises steps of: (a) receiving the authentication request; (b) generating and responding a session ID; (c) receiving the open ID and on-time-password (OTP); and (d) sending the open ID, the session ID and the OTP to the open ID converting server, wherein the OTP is generated by a smart card reader according to two parameter of the session ID and the hidden code;
the second converting procedure comprises steps of: (a) receiving the open ID, the session ID and the OTP to the open ID converting server; (b) reading the open ID to real ID database to convert open ID to the corresponding real ID; and (c) sending the real ID, the session ID and the OTP to the real ID authentication server; and
the third converting procedure comprises steps of: (a) receiving the real ID, the session ID and the OTP; (b) generating a real ID related data and recovering the hidden code according to the real ID; (c) verifying the OTP according to the real ID related data, session ID and the hidden code; and (d) generating and responding an authentication result to end user.

11. The multi-layer data mapping authentication system as claimed in claim 7, wherein
the first converting procedure comprises steps of: (a) receiving authentication request; (b) responding a session ID; (c) receiving the external ID and an OTP; (d) reading the external ID to central ID converting database to to convert the external ID to the central ID; and (e) sending the central ID, the session ID and OTP to the central ID converting server; wherein the OTP is generated by the smart card reader according to two parameters of the session ID and the hidden code;
the second converting procedure comprises steps of: (a) receiving the central ID, the session ID and an OTP; (b) reading the central ID to partial real data converting database to convert the central ID to the corresponding partial real data; and (c) sending the partial real data, the session ID and the OTP to the real ID authentication server; and
the third converting procedure comprises steps of: (a) receiving the partial real data, the session ID and the OTP; (b) generating a real ID related data and recovering the hidden code according the partial real data; (c) verifying the OTP according to the real ID related data, the session ID and hidden code; and (d) responding an authentication result to the end user.

12. The multi-layer data mapping authentication system as claimed in claim 5, wherein
the first converting procedure comprises steps of: (a) receiving an authentication request from the end user; (b) sending a session ID generated by terminal data mapping server; (c) receiving an central ID and an OTP; and (d) sending the central ID, the session ID and OTP to the central ID converting server; wherein the OTP is generated by the smart card reader according to two parameters of the session ID and hidden code;
the second converting procedure comprises steps of: (a) receiving the central ID, the session ID and the OTP; (b) reading the central ID to open ID converting database to convert the central ID to the corresponding open ID; (c) sending the opening ID, the session ID and OTP to the open ID converting server; (d) reading the open ID to real ID converting database to convert the open ID to the corresponding real ID; (e) sending the real ID, the session ID and OTP to the real ID authentication server; and
the third converting procedure comprises steps of: (a) receiving the real ID, the session ID and OTP; (b) generating a real ID related data and recovering the hidden code according the real ID; (c) verifying the OTP according to the real ID related data, the session ID and hidden code; and (d) responding an authentication result to the end user.

13. The multi-layer data mapping authentication system as claimed in claim 8, wherein
the first converting procedure comprises steps of: (a) receiving an authentication request; (b) sending a session ID generated by the external server; (c) receiving the external ID and an OTP; and (d) reading the external ID to central ID converting database to convert the external ID to the corresponding central ID; and (e) sending the central ID, the session ID and the OTP to the central ID converting server; wherein the OTP is generated by the smart card reader according to the two parameter of the session ID and the hidden code;
the second converting procedure comprises steps of: (a) receiving the central ID, the session ID and the OTP; (b) reading the central ID to open ID converting database to convert the central ID to the corresponding open ID; (c) sending the opening ID, the session ID and OTP to the open ID converting server; (d) reading the open ID to real ID converting database to convert the open ID to the corresponding real ID; (e) sending the real ID, the session ID and OTP to the real ID authentication server; and
the third converting procedure comprises steps of: (a) receiving the real ID, the session ID and OTP; (b) generating a real ID related data and recovering the hidden code according the real ID; (c) verifying the OTP according to the real ID related data the session ID and hidden code; and (d) responding an authentication result to the end user.

14. The multi-layer data mapping authentication system as claimed in claim 8, wherein
the first converting procedure comprises steps of: (a) receiving an authentication request; (b) sending a session ID request to the central ID converting server; (c) receiving the session ID generated by the central ID converting server and then sending the session ID to the end user; (d) receiving the external ID and an OTP; (e) reading the external ID and central ID converting database to convert the external ID to the corresponding central ID; and (f) sending the central ID and the OTP to the central ID converting server; wherein the OTP is generated by the smart card reader according to two parameter of the session ID and hidden code;
the second converting procedure comprises steps of: (a) receiving the central ID, the session ID and the OTP; (b) reading the central ID to open ID converting database to convert the central ID to the corresponding open ID; (c) sending the opening ID, the session ID and OTP to the open ID converting server; (d) reading the open ID to real ID converting database to convert the open ID to the corresponding real ID; (e) sending the real ID, the session ID and OTP to the real ID authentication server; and
the third converting procedure comprises steps of: (a) receiving the real ID, the session ID and OTP; (b) generating a real ID related data and recovering the hidden code according the real ID; (c) verifying the OTP according to the real ID related data, the session ID and hidden code; and (d) responding an authentication result to the end user.

15. The multi-layer data mapping authentication system as claimed in claim 8, wherein
the first converting procedure comprises steps of: (a) receiving an authentication request; (b) sending a session ID request to the real ID authentication server; (c) receiving the session ID generated by the real ID and then sending the session ID to the end user; (d) receiving the external ID and the OTP; (e) reading the external ID and central ID converting database to convert the external ID to the corresponding central ID; and (f) sending the central ID and the OTP to the central ID converting server; wherein the OTP is generated by the smart card reader according to two parameter of the session ID and hidden code;
the second converting procedure comprises steps of: (a) receiving the central ID and OTP; (b) reading the central ID to open ID converting database to convert the central ID to the corresponding open ID; (c) sending the opening ID and the OTP to the open ID converting server; (d) reading the open ID to real ID converting database to convert the open ID to the corresponding real ID; (e) sending the real ID and the OTP to the real ID authentication server; and
the third converting procedure comprises steps of: (a) receiving the real ID and the OTP; (b) generating a real ID related data and recovering the hidden code according the real ID; (c) verifying the OTP according to the real ID related data and hidden code; and (d) responding an authentication result to the end user.

16. The multi-layer data mapping authentication system as claimed in claim 6, wherein
the first converting procedure comprises steps of: (a) receiving an authentication request; (b) sending the session ID; (c) receiving the central ID and an OTP; and (d) sending the central ID, the session ID and the OTP to the open ID converting server; wherein the OTP is generated by the smart card reader according to the two parameters of the session ID and hidden code;
the second converting procedure comprises steps of: (a) receiving the central ID, the session ID and the OTP; (b) sending the central ID to the central ID converting server; (c) converting the central ID to the corresponding open ID by the central ID converting server; (d) receiving the open ID from the central ID converting server and converting the open ID to the corresponding real ID; and (e) sending the real ID, the session ID and OTP to the real ID authentication server; and
the third converting procedure comprises steps of: (a) receiving the real ID, the session ID and OTP; (b) generating a real ID related data and recovering the hidden code according the real ID; (c) verifying the OTP according to the real ID related data the session ID and hidden code; and (d) responding an authentication result to the end user.

17. The multi-layer data mapping authentication system as claimed in claim 2, wherein the real ID authentication server stores bank accounts corresponding to the real IDs, and the external server allows a payer and a recipient to link to execute a payment procedure;
the first converting procedure comprises steps of: (a) receiving the authentication request from the payer (b) sending a session ID request to the open ID converting server; (c) receiving and responding the session ID generated by open ID converting server; (d) receiving an open ID, amount, a recipient's open ID and an OTP; and (e) sending the payer's open ID, the amount, the session ID and the recipient's open ID and the OTP to the open ID converting server;
the second converting procedure comprises steps of: (a) receiving payer's open ID, the amount, the session ID and the recipient's open ID and the OTP; (b) reading the open ID to real ID converting database to convert the payer's open ID to the corresponding real ID; and (c) sending the payer's real ID, the session ID and the OTP to the real ID authentication server; and
the third converting procedure comprises steps of: (a) receiving payer's real ID, the session ID and the OTP; (b) generating a real ID related data and recovering the hidden code according to the real ID; (c) verifying the OTP according to the real ID related data, session ID and the hidden code; (d) transferring the money from the payer's account to the recipient's bank account through the central ID converting server if an authentication result is success; (e) sending a notice of successful payment to the recipient.

18. The multi-layer data mapping authentication system as claimed in claim 1, wherein the real ID authentication server stores bank accounts corresponding to the real IDs; the middle data mapping server links to the private network and has an open ID converting server and the public ID to real ID converting database is an open ID to real ID converting database, wherein the open ID is the public ID; and the terminal data mapping server is a central ID converting server having a central ID to open ID converting database and a central ID balance database and allowing a payer and a recipient to link to execute a payment procedure;
the first converting procedure comprises steps of: (a) receiving a payment authentication request; (b) responding a session ID generated by a central ID; (c) receiving a payer's central ID, amount, a recipient central ID and an OTP; (d) reading the central ID to open ID converting database to covert the payer's central ID to the corresponding open ID; and (d) sending the payer's open ID, amount, the session ID and the OTP to the open ID converting server;
the second converting procedure comprises steps of: (a) receiving the payer's open ID, amount, the session ID and the OTP; (b) reading the open ID to real ID converting database to convert the payer's open ID to the corresponding real ID; and (c) sending the payer's real ID, the session ID and the OTP to the real ID authentication server; and
the third converting procedure comprises steps of: (a) receiving the payer's real ID, the session ID and the OTP; (b) generating a real ID related data and recovering the hidden code according to the real ID; (c) verifying the OTP according to the real ID related data, the session ID and the hidden code; (d) transferring the money from the payer's account to the recipient's bank account through the central ID converting server if an authentication result is success; (e) sending a notice of successful payment to the recipient.

19. The multi-layer data mapping authentication system as claimed in claim 1, wherein the real ID authentication server stores bank accounts corresponding to the real IDs; the middle data mapping server links to the private network and has an open ID converting server and the public ID to real ID converting database is an open ID to real ID converting database, wherein the open ID is the public ID; and the terminal data mapping server is a central ID converting server having a central ID to open ID converting database and a central ID balance database and allowing a payer and a recipient to link to execute a payment procedure;
the first converting procedure comprises steps of: (a) receiving a payment authentication request; (b) receiving a payer's central ID, amount, a recipient central ID and an OTP; (c) reading the central ID to open ID converting database to covert the central ID to the corresponding open ID; and (d) sending the payer's open ID, the amount and the OTP to the open ID converting server;
the second converting procedure comprises steps of: (a) receiving the payer's open ID, the amount and the OTP; (b) reading the open ID to real ID converting database to convert the payer's open ID to the corresponding real ID; and (c) sending the payer's real ID and OTP to the real authentication server; and
the third converting procedure comprises steps of: (a) receiving the payer's real ID, the session ID and the OTP; (b) generating a real ID related data and recovering the hidden code according to the real ID; (c) verifying the OTP according to the real ID related data, the session ID and the hidden code; (d) transferring the money from the payer's account to the recipient's bank account through the central ID converting server if an authentication result is success; (e) sending a notice of successful payment to the recipient.

20. A multi-layer data mapping authentication system comprising:
a real ID authentication server linking to a private network and further having at least one real ID database and building a third converting procedure, wherein the real ID authentication server has a real ID database storing real IDs;
a middle data mapping server building a second converting procedure and having:
an open ID converting server linking to the private network and the real ID authentication server, and having an open ID to real ID converting database storing the open IDs and the real IDs; and
a central ID converting server linking to a public network and the open ID converting server, and having a central ID to open ID converting database storing the central IDs and the open IDs; and
an external server linking to the public network and the central ID converting server, and building a first converting procedure and an external ID to central ID converting server storing external IDs corresponding to the central IDs; wherein external server allows an end user to link so that the end user sends a user's code related to the corresponding external ID and an one-time-password (OTP) generated by a smart card reader according to an external ID.

21. The multi-layer data mapping authentication system as claimed in claim 20, wherein
the first converting procedure comprises steps of: (a) receiving an authentication request; (b) sending a session ID generated by the external ID; (c) receiving the external ID and an OTP; and (d) reading the external ID to central ID converting database to convert the external ID to the corresponding central ID; and (e) sending the central ID, the session ID and the OTP to the central ID converting server; wherein the OTP is generated by the smart card reader according to the one parameter of the session ID;
the second converting procedure comprises steps of: (a) receiving the central ID, the session ID and the OTP; (b) reading the central ID to open ID converting database to convert the central ID to the corresponding open ID; (c) sending the opening ID, the session ID and OTP to the open ID converting server; (e) reading the open ID to real ID converting database to convert the open ID to the corresponding real ID; (f) sending the real ID, the session ID and OTP to the real ID authentication server; and
the third converting procedure comprises steps of: (a) receiving the real ID, the session ID and OTP; (b) generating a real ID related data according the real ID; (c) verifying the OTP according to the real ID related data the session ID; and (d) responding an authentication result to the end user.

22. A multi-layer data mapping authentication system comprising:
a real ID authentication server linking to a private network and further having at least one real ID database and building a third converting procedure, wherein each of the at least one real ID database of the real ID authentication server stores multiple real IDs;
a middle data mapping server building a second converting procedure and having:
an open ID converting server linking to a private network and the real ID authentication server, and having an open ID to real ID converting database storing the open IDs and the real IDs; and
a central ID converting server linking to the open ID converting server, and having a central ID to open ID converting database storing the central IDs and the open IDs; and
an external server linking to the public network and the open ID converting server, and building a first converting procedure; wherein external server allows an end user to link so that the end user sends a user's code related to the corresponding central ID and an one-time-password (OTP) generated by a smart card reader according to an central ID.

23. The multi-layer data mapping authentication system as claimed in claim 22, wherein
the first converting procedure comprises steps of: (a) receiving an authentication request; (b) sending a session ID; (c) receiving the central ID and an OTP; and (d) sending the central ID, the session ID and the OTP to the open ID converting server; wherein the OTP is generated by the smart card reader according to the one parameter of the session ID;
the second converting procedure comprises steps of: (a) receiving the central ID, the session ID and the OTP; (b) sending the central ID to the central ID converting server; (c) converting the central ID to open ID corresponding open ID by central ID converting server; (d) receiving the open ID from the central ID converting server and converting the open ID to the corresponding real ID; and (e) sending the real ID, the session ID and OTP to the real ID authentication server; and
the third converting procedure comprises steps of: (a) receiving the real ID, the session ID and OTP; (b) generating a real ID related data according the real ID; (c) verifying the OTP according to the real ID related data the session ID; and (d) responding an authentication result to the end user.
